(19) United States
(12) Patent Application Publication
(10) Pub. No.: US 2013/0033358 A1
(43) Pub. Date: Feb. 7, 2013

(54) SYSTEM, SENDER AND CONTROL METHOD

(71) Applicants: Hitoshi YAMAZAKI, Yamazaki (JP); Takao Sawano, Kyoto (JP)

(72) Inventors: Hitoshi YAMAZAKI, Yamazaki (JP); Takao Sawano, Kyoto (JP)

(73) Assignee: NINTENDO CO., LTD., Kyoto (JP)

(21) Appl. No.: 13/561,594

(22) Filed: Jul. 30, 2012

(30) Foreign Application Priority Data
Aug. 5, 2011 (JP) 2011-171803

(51) Int. Cl. G05B 23/02

(52) U.S. Cl. 340/3.1

(57) ABSTRACT

A non-limiting example system includes at least one sender, and a beacon signal sent from the sender is received by a portable terminal. In accordance with a sender ID included in the beacon signal, the portable terminal displays on an LCD a map image and a current position of the portable terminal or a user having the portable terminal, and displays on the LCD a guide image as for events or exhibition items in a predetermined place. Furthermore, the portable terminal stores state information included in the beacon signal for each sender (sender ID), and transmits or moves the state information to a central terminal at a predetermined timing.

### CROSS REFERENCE OF RELATED APPLICATION

The disclosure of Japanese Patent Application No. 2011-171803 filed on Aug. 5, 2011 is incorporated herein by reference.

### FIELD

This application describes a system, a sender and a control method, providing predetermined information.

### SUMMARY

It is a primary object of embodiments to provide a novel system, sender and control method.

It is another object of the embodiments to provide a system, sender and control method each capable of sending a stable signal with easy control.

A first embodiment is a system comprising at least one portable terminal, at least one sender which sends a signal receivable by the portable terminal, and a central terminal which receives a signal from the portable terminal. The sender sends a signal including process information relating to a predetermined process to be executed by the portable terminal and state information indicative of a state of at least the sender. The portable terminal executes the predetermined process with using the process information included in the signal that is received from the sender, and transmits the state information included in the signal to the central terminal. Then, the central terminal receives and processes the state information from the portable terminal.

According to the first embodiment, since the sender sends the signal including the process information and the state information, the portable terminal which receives the signal performs the predetermined process, and collects the state information of the sender to transmit the state information to the central terminal. Therefore, it is possible to easily control or manage the state information of the sender. Furthermore, since maintenance of the sender can be performed as necessary, it is possible to send a stable signal.

More specifically, a system which provides a predetermined service to a user, and comprises the portable terminal which is used for providing the service, a sender which sends information available to provision of the service to the portable terminal, and a central terminal capable of communicating with the portable terminal. The portable terminal receives the information sent by the sender, and on the basis of received information, executes the process for providing the service, whereby the user can receive the service. On the other hand, the sender also sends the information indicative of a state of a sender as well as the information available to provision of the service, and therefore, the portable terminal also receives that information. The portable terminal stores the received information indicative of the state of the sender, and at a timing that the portable terminal becomes possible to communicate with the central terminal, transmits the information indicative of the state of the sender being stored therein to the central terminal. Thus, the central terminal can collect the information of the respective senders.

A second embodiment is according to the first embodiment, wherein the sender is of a portable-type.

According to the second embodiment, because the sender is a portable-type sender, the sender can be installed at a desired location, and even if the location or the place that the sender is installed is to be changed, it is possible to easily move and reinstall the sender. In a case that the sender is thus moved, it is necessary to confirm whether the sender is stably supplied with a power, to confirm whether the signal is being sent stably, and therefore, the control or management of the sender is troublesome, but, even in such a case, according to this embodiment, it is possible to efficiently perform the control or management of the sender.

A third embodiment is according to the first embodiment, wherein the sender is powered by a battery. The state information includes information associated with a residual quantity of the battery (battery voltage).

According to the third embodiment, since the state information includes the information associated with the residual quantity of the battery, even if the residual quantity of the battery is reduced, it is possible to exchange or charge the battery before the dead battery. That is, it is possible to send a stable signal while avoiding the dead battery.

A fourth embodiment is according to the first embodiment, wherein the state information includes information associated with the number of times that the sender is moved.

According to the fourth embodiment, since the state information includes the number of times that the sender is moved, in a case that the number of times that the sender is moved is large, it is possible to easily assume that the sender is substantially shifted from the location that the sender was previously installed. Therefore, it is possible to return-back the location that the sender is installed to send a stable signal.

A fifth embodiment is according to the first embodiment, wherein the sender includes a luminance sensor. The state information includes information associated with a detection value of the luminance sensor.

According to the fifth embodiment, it is possible to switch an operation or a stop of the sender according to the detection value of the luminance sensor. Especially, in a case that the sender is powered by the battery, by operating the sender according to the brightness or darkness, it is possible to reduce waste power consumption.

A sixth embodiment is according to the fifth embodiment, wherein the state information further includes information of a threshold value that is to be set for the luminance sensor.

According to the sixth embodiment, the operation or the stop of the sender can be switched in accordance with whether or not the detected luminance exceeds the predetermined threshold value, and furthermore, it is possible to determine whether or not the predetermined threshold value is correctly set. That is, it is possible to know whether or not the sender is suitably operated and stopped.

A seventh embodiment is according to the first embodiment, wherein the state information includes information associated with a sending interval of the signal.

According to the seventh embodiment, the state information includes the information associated with the sending interval of the signal, and therefore, it is possible to know whether the sender is correctly operated at the set sending interval. That is, it is possible to know whether the signal is correctly received at a side of the portable terminal. Furthermore, in a case that the sender is powered by the battery, it is possible to know whether the power is not wastefully consumed.

An eighth embodiment is according to the first embodiment, wherein the state information includes information associated with output strength of the signal.

According to the eighth embodiment, it is possible to know whether or not the output strength of the signal is correctly set.

A ninth embodiment is according to the first embodiment, wherein the sender includes a transmitter which transmits the state information to the portable terminal. The state information includes inherent information of the transmitter (MAC address) and identifying information (ID) assigned to the sender.

According to the ninth embodiment, since the inherent information of the transmitter and the identifying information assigned to the sender are included in the state information, even if the sender is exchanged, it is not necessary to largely change a system by assigning the same identifying information to the exchanged sender, and therefore, the operation and the control or management of the system are easy.

A tenth embodiment is according to the first embodiment, wherein the process information includes information relating to the location of the sender.

According to the tenth embodiment, since the process information includes the information relating to a location of the sender, in the portable terminal, it is possible to execute the process based on the information.

An eleventh embodiment is according to the tenth embodiment, wherein the portable terminal obtains a position of the portable terminal by using the information relating to the location of the sender, and performs the process based on the position of the portable terminal thus obtained as the predetermined process.

According to the eleventh embodiment, by obtaining the position of the portable terminal, it is possible to indicate the position on the map or to present the information as for an object arranged at the position, for example.

A twelfth embodiment is according to the first embodiment, wherein the process information includes information of a time counted by the sender.

According to the twelfth embodiment, it is possible to adjust the time being counted by the portable terminal, for example, based on the information of the time counted by the sender.

A thirteenth embodiment is a sender which sends a signal receivable by a portable terminal. The signal includes process information relating to a predetermined process to be executed by the portable terminal and state information indicative of a state of at least the sender itself.

According to the thirteenth embodiment, as similar to the first embodiment, a stable signal can be sent.

A fourteenth embodiment is according to the thirteenth embodiment, wherein the sender is of a portable-type.

According to the fourteenth embodiment, as similar to the second embodiment, it is possible to install the sender at a desired location, and to move the sender easily.

A fifteenth embodiment is according to the thirteenth embodiment, wherein the sender is powered by a battery, and the state information includes information associated with a residual quantity of the battery.

According to the fifteenth embodiment, as similar to the third embodiment, it is possible to send a stable signal while the dead battery is avoided.

A sixteenth embodiment is according to the thirteenth embodiment, wherein the state information includes information associated with the number of times that the sender itself is moved.

According to the sixteenth embodiment, as similar to the fourth embodiment, it is possible to send a stable signal by returning-back the installed location of the sender.

A seventeenth embodiment is according to the thirteenth embodiment, wherein the process information includes information relating to a location of the sender itself.

According to the seventeenth embodiment, as similar to the tenth embodiment, it is possible to execute the process based on the information relating to the location of the sender at a side of the portable terminal.

An eighteenth embodiment is according to the thirteenth embodiment, wherein the signal is a beacon signal.

According to the eighteenth embodiment, in the portable terminal held and moved by the user, for example, it is possible to receive the beacon signal.

A nineteenth embodiment is according to the thirteenth embodiment, wherein the signal is sent while no address is designated.

According to the nineteenth embodiment, since the signal is sent without designating address, even if the information of a recipient is not made known, it is possible to notify the state information indicative of a state of the sender itself at a side of the sender.

A twentieth embodiment is a control method of controlling equipment by using at least one portable terminal, at least one sender which sends a signal receivable by the portable terminal, and a central terminal which receives a signal from the portable terminal. The sender sends the signal including process information relating to a predetermined process to be executed by the portable terminal and state information indicative of a state of at least the sender. The portable terminal executes the predetermined process with using the process information included in the signal received from the sender, and transmits the state information included in the signal to the central terminal. Then, the central terminal receives and processes the state information from the portable terminal.

According to the twentieth embodiment, as similar to the first embodiment, it is possible to send a stable signal.

The above described objects and other objects, features, aspects and advantages of the embodiments will become more apparent from the following detailed description of the embodiments when taken in conjunction with the accompanying drawings.

### BRIEF DESCRIPTION OF THE DRAWINGS

FIG. 1 is an illustrative view showing a non-limiting example system.

FIG. 2 is an illustrative view showing a non-limiting example predetermined place that the system shown in FIG. 1 is applied.

FIG. 3 is an illustrative view showing a non-limiting example appearance and structure of a sender shown in FIG. 1.

FIG. 4 is a block diagram showing a non-limiting example electric structure of the sender shown in FIG. 1.

FIG. 5 is a block diagram showing a non-limiting example electric structure of the portable terminal shown in FIG. 1

FIG. 6 is an illustrative view showing a non-limiting example specific content of a beacon signal sent from the sender shown in FIG. 1.

FIG. 7 is an illustrative view showing a non-limiting example memory map of a flash memory incorporated within the sender shown in FIG. 1.

FIG. 8 is an illustrative view showing a non-limiting example memory map of a flash memory incorporated within the portable terminal shown in FIG. 1.

FIG. 9 is an illustrative view showing a non-limiting example specific content of state information data shown in FIG. 8.

FIG. 10 is an illustrative view showing a non-limiting example state information totalized in a central terminal shown in FIG. 1.

### DETAILED DESCRIPTION OF NON-LIMITING EXAMPLE EMBODIMENTS

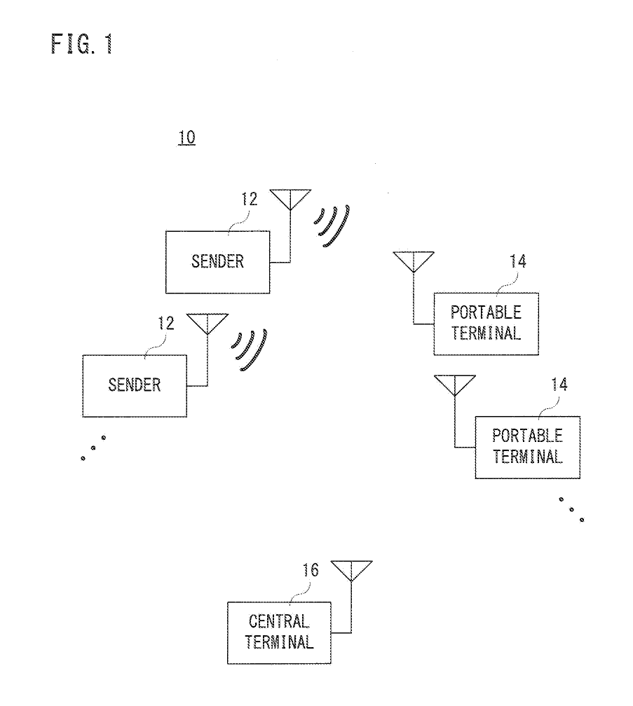

With referring to FIG. 1, a non-limiting example embodiment system 10 includes a plurality of senders 12, a plurality of portable terminals 14 and a central terminal 16. In FIG. 1, it is shown that the senders 12 and the portable terminals 14 are respectively provided in the plural number, but not limited. Any one of the senders 12 and portable terminals 14 or both of them may be only one.

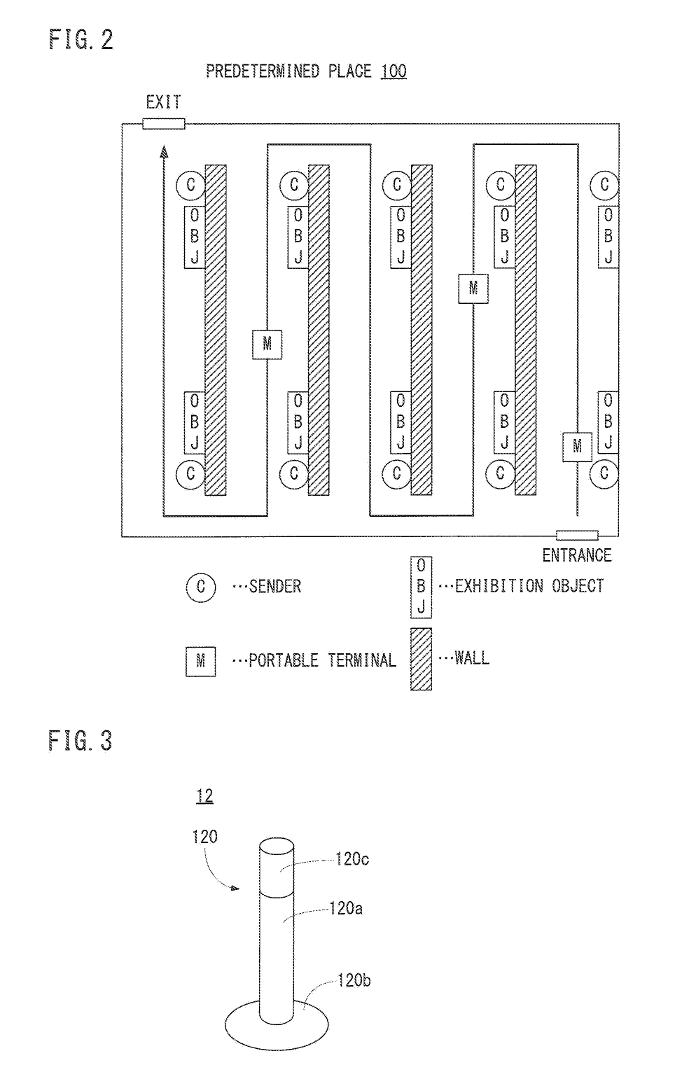

As shown in FIG. 2, the system 10 is utilized in a predetermined place 100 such as an exhibition hall, for example, and respective one of the plurality of senders 12 (in FIG. 2, indicated by a circle with ‘C’) is placed at a desired location, and operates independently. For example, the desired location may be a passage in the place, room, doorway, booth, exhibition position of an object (exhibition item); however, in the embodiment shown in FIG. 2, respective senders 12 are installed at or near exhibition positions of respective objects OBJ.

Although a detailed description is omitted here, the senders 12 are put on a floor, or fixed on a wall or ceiling, but may be fixed to the floor. As a fixing member or fixing tool, although screws or bolts are typically used, in some cases, may be adhesion.

In addition, since the sender 12 is of a portable-type, it is possible to install the sender 12 at a desired location within the predetermined place 100, and even if the place is changed, movement or reinstallation of the sender 12 is easy.

The portable terminal 14 (in FIG. 2, indicated by a square with ‘M’) is used by a user (not shown) who visits the predetermined place 100, and lent to the user at a time that the user enters the predetermined place 100 by an exhibition manager, for example. As shown in FIG. 2, the user moves in the predetermined place 100 by the route shown by a solid line and an arrow mark while having the portable terminal 14, and appreciates objects OBJ. At that time, a predetermined service is provided to the user who uses the portable terminal 14 by using the portable terminal 14.

More specifically, the portable terminal 14 receives a signal (a beacon signal, in this embodiment) from the sender 12 and displays on a screen a map image (sketch) in accordance with the signal, and then, displays on the map image a current position of the portable terminal 14 or the user using the portable terminal 14. For example, a birds-eye-view as shown in FIG. 2, viewing of the predetermined place 100 from the above, is displayed. Furthermore, the portable terminal 14 receives the beacon signal from the sender 12, and displays on the screen a guide image such as an explanation of the exhibition object OBJ, or outputs a voice guide. Furthermore, the portable terminal 14 receives the beacon signal from the sender 12 and adjusts (corrects) a time counted by itself according to the beacon signal. Therefore, a correct time is shown to the user.

However, these are only examples, and the portable terminal 14 executes a predetermined process in accordance with a signal from the sender 12, and provides to the user some information or services as a result of the predetermined process.

The user returns the portable terminal 14 to the exhibition manager at a time that the user departs from the predetermined place 100. Although not shown in FIG. 2, the central terminal 16 may be arranged in the vicinity of an exit of the predetermined place 100, or in a place where the returned portable terminal 14 is kept, or in a place that the exhibition manager is stationed. However, such the arrangement positions of the central terminals 16 are only examples. As described later, information (state information) as for the plurality of senders 12 that are stored (collected) by the portable terminal 14 should be received by the central terminal 16.

The state information is transmitted from the portable terminal 14 to central terminal 16 at a predetermined timing. The predetermined timing is, for example, a timing that the portable terminal 14 is put on a charging base or a timing that a predetermined switch of the portable terminal 14 is operated.

In addition, the portable terminal 14 and the central terminal 16 may directly communicate with each other, or communicate with each other via a network.

FIG. 3 shows one example of appearance structure of the sender 12. The sender 12 in this embodiment includes a housing 120 having a predetermined shape and a predetermined size. The housing 120 is constructed of three (3) members of a pole portion 120a, a base 120b and a top portion 120c when divided roughly. The pole portion 120a is formed in a cylindrical shape, and formed by a metal such as aluminum, stainless-steel or the like or a resin such as a plastic. The base 120h fixes the pole portion 120a at one end of the pole portion, and similar to the pole portion 120a, is formed by a metal or resin. Although a detailed description is omitted here, in a case that the pole portion 120a and the base 120b are formed by a resin, an opaque resin is used to hide internals of the pole portion 120a and base 120b. The top portion 120c is formed to be attachable to or detachable from another end of the pole portion 120a, and formed by a semi-transparent resin. In addition, the top portion 120c may be formed with transparency or semi-transparency at only a portion corresponding to a position that a luminance sensor 28 described later is arranged out of an upper surface (a top surface) and a peripheral surface.

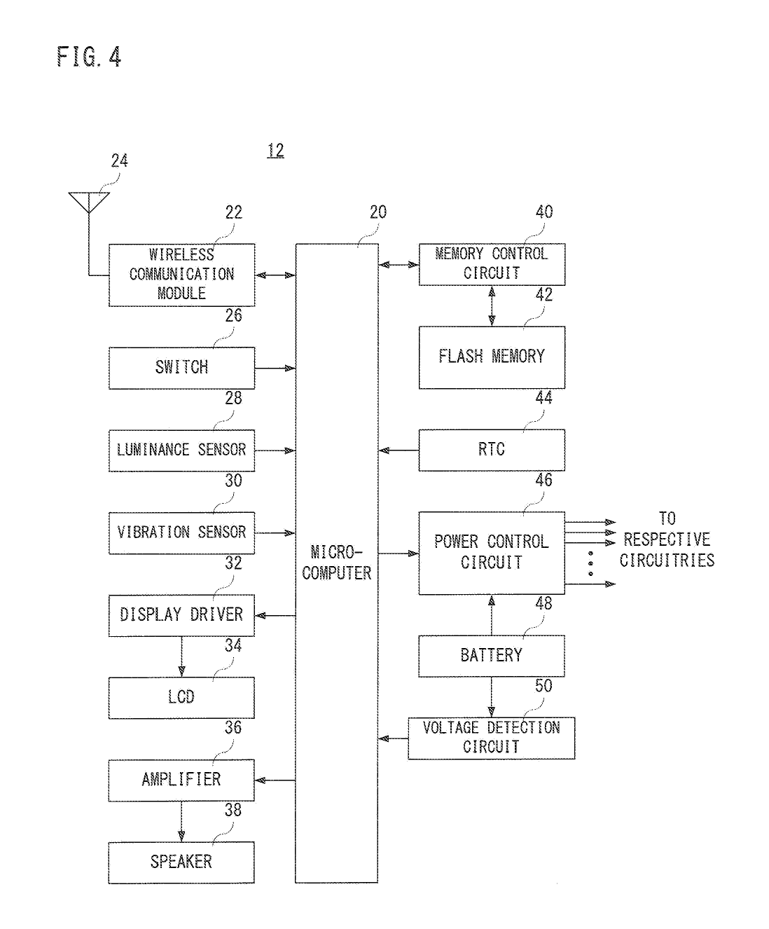

FIG. 4 is a block diagram showing an example of electrical structure of the sender 12. Although not shown, respective circuitry components of the sender 12 shown in FIG. 4 are mounted on a printed circuit board, and then, housed (accommodated) inside the housing 120 (pole portion 120a and top portion 120c) shown in FIG. 3. Therefore, although not shown, an antenna 24 and a luminance sensor 28 are mounted or arranged at positions inside the top portion 120c. Such an arrangement is for sending the beacon signal outside and detecting an environmental luminance.

As shown in FIG. 4, the sender 12 includes a microcomputer 20 to which a wireless communication module 22, a switch 26, the luminance sensor 28, a vibration sensor 30, a display driver 32, an amplifier 36, a memory control circuit 40, an RTC 44, a power control circuit 46 and a voltage detection circuit 50 are connected.

Furthermore, the wireless communication module 22 is connected with the antenna 24. The display driver 32 is connected with an LCD 34. To the amplifier 36, a speaker 38 is connected. A flash memory 42 is connected to the memory control circuit 40. A battery 48 is connected to the power control circuit 46 and the voltage detection circuit 50.

The microcomputer 20 controls a whole operation of the sender 12, and at predetermined time interval, generates a predetermined signal (beacon signal) described later, and sends or transmits the generated beacon signal via the wireless communication module 22 and the antenna 24 without address designation. The wireless communication module 22 is a communication device according to a predetermined wireless standard (IEEE802.11b in this embodiment), and outputs (sends) from the antenna 24 the beacon signal applied from the microcomputer 20.

Although not shown, the switch 26 includes a cross switch and a push-button switch, which are used for setting and changing each setting item as for the beacon signal. The luminance sensor 28 is a general-purpose luminance sensor, and detects an environmental luminance of the sender 12, and applies a detection value to the microcomputer 20. The vibration sensor 30 is a general-purpose slant (angular) sensor, and detects an inclined or moved state (vibration), and applies a detection result to the microcomputer 20. Therefore, the number of vibration times is measured by the microcomputer 20.

In addition, since the sender 12 is powered by the battery 48 in this embodiment, in order to make the power consumption as little as possible, the slant (angular) sensor is used. However, in a case that the sender 12 is powered by a commercial power supply, because it is not necessary to worry about the dead battery, it is possible to use an acceleration sensor instead of the slant (angular) sensor.

The display driver 32 controls a display of the LCD 34 according to the instructions by the microcomputer 20. The LCD 34 displays a screen for setting respective setting items as for the sender 12. Although not shown, a number assigned to each setting item and setting value is displayed. Therefore, instead of the LCD 34, a display comprising two (2) 7-segment LEDs may be used. In this case, one 7-segment LED displays a numeral or symbol distinguishing a setting item, and the other 7-segment LED displays a numeral of the setting value or a symbol or sign corresponding to the setting value.

The amplifier 36 amplifies a sound signal from the microcomputer 20, and outputs an amplified sound signal to the speaker 38. In this embodiment shown, a sound (alarm) is output (sounded) when the vibration of the sender 12 is detected by the vibration sensor 30. The memory control circuit 40 writes data in the flash memory 42 or read data from the flash memory 42 according to the instructions by the microcomputer 20.

In addition, the flash memory 42 is used in the embodiment shown, but other non-volatile memory such as an EEPROM may be used. In addition, the non-volatile memory may be incorporated within the microcomputer 20.

The RTC 44 is a time piece circuit counting a time (including year, month, day), and applies data of a counted time to the microcomputer 20 in response to a request from the microcomputer 20. The power control circuit 46 is a circuitry for stepping-down the power supply voltage supplied by the battery 48 and rectifying (noise eliminating) to supply or stop the power to the respective circuitry components according to the instructions by the microcomputer 20. However, although a detailed description is omitted here, the power is always applied to the microcomputer 20 and the RTC 44.

The battery 48 includes a plurality of (four, in this embodiment shown) primary batteries or secondary batteries being connected in series. The voltage detection circuit 50 detects a voltage value of the battery 48, and applies to the microcomputer 20 data of a detection voltage value. A reason why the sender 12 is thus powered by the power from the battery 48 is for avoiding a situation that the installation location of the sender 12 becomes to be restricted by a position of an outlet (not shown) for receiving the supply of the commercial power.

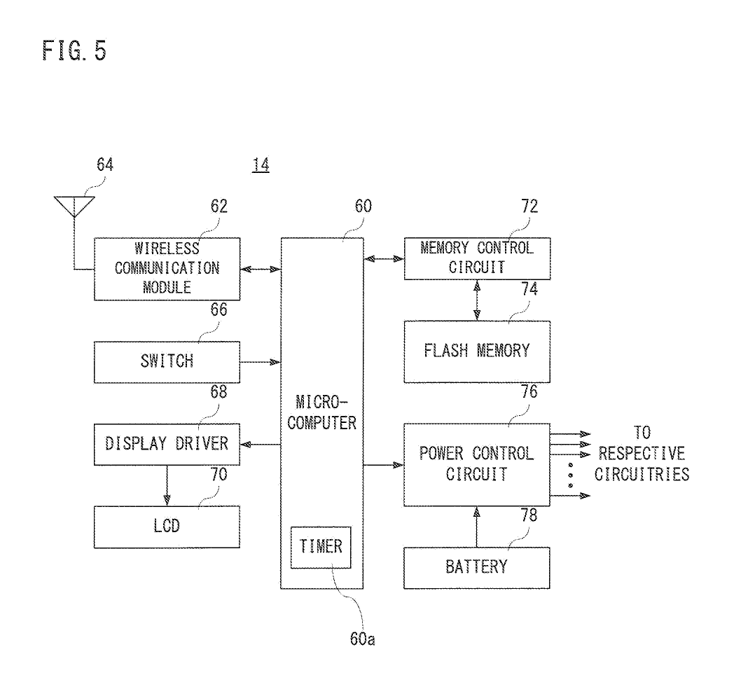

FIG. 5 is a block diagram showing one example of electrical structure of the portable terminal 14. In the following, a description for respective circuitry components of the portable terminal 14 will be made, but about the same or similar components as those of the sender 12 previously described, a description will be made simple.

As shown in FIG. 5, the portable terminal 14 includes a microcomputer 60 to which a wireless communication module 62, a switch 66, a display driver 68, a memory control circuit 72 and a power control circuit 76 are connected. The microcomputer 60 controls a whole operation of the portable terminal 14. The microcomputer 60 is incorporated with a timer 60a to count a time (including year, month, day). The wireless communication module 62 is a communication device according to the predetermined wireless standard (the same as that of the wireless communication module 22 of the sender 12). In this embodiment shown, the wireless communication module 62 receives the beacon signal from the sender 12 via an antenna 64 to apply the beacon signal to the microcomputer 60. The wireless communication module 62 further transmits to the central terminal 16 via the antenna 64 information (state information) about a state of the sender 12, being applied by the microcomputer 60. The state information will be described later in detail.

Although not shown, the switch 66 includes a cross switch and a push-button switch, which are used to instruct a start and an end of a predetermined process executed in the portable terminal 14, or to instruct displaying on an LCD 70 a processed result of the predetermined process. However, instead of the switch 66, a pointing device such as a touch panel may be provided.

The display driver 68 controls a display by the LCD 70 according to the instructions by the microcomputer 60. As described above, a processed result of the predetermined process is displayed. In this embodiment shown, a map image of the predetermined place 100 and a current position of the portable terminal 14 or a user holding the portable terminal 14 are displayed on the LCD 70, or an event at the current position of the portable terminal 14 or user, or a content of an explanation of the exhibition object OBJ (guide image: image and text, or only text) are displayed.

In addition, although not shown, the display driver 68 is incorporated with a memory (VRAM) for image rendering, and the image data applied from the microcomputer 60 is temporarily stored in the VRAM, and then, output to the LCD 70.

The memory control circuit 72 writes data in a flash memory 74 and reads data from the flash memory 74 according to the instructions of the microcomputer 60. According to the instructions of the microcomputer 60, the power control circuit 76 steps-down and rectifies a power source voltage from the battery 78 to supply or stop the power to respective circuitry components.

Although not shown, the central terminal 16 is a computer such as a general-purpose personal computer or server, and in this embodiment shown, provided with a communication function, and therefore, it is possible for the central terminal 16 to communicate with the portable terminal 14 in a wireless fashion.

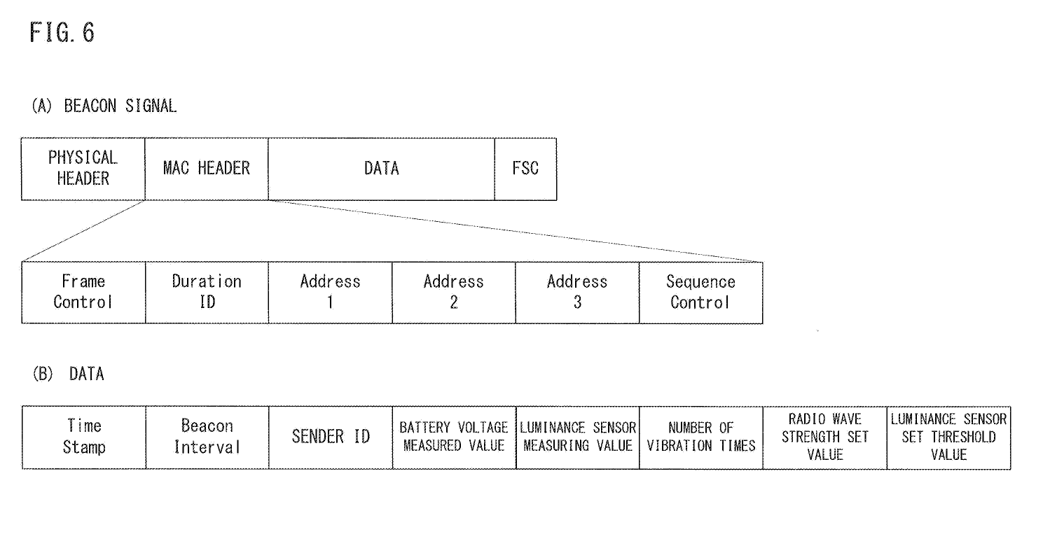

FIG. 6(A) is an illustrative view showing a frame format of the above-described beacon signal. The frame format is decided in advance by the wireless standard. In this embodiment shown, in order to be accordance with the standard of IEEE802.11b, as shown in FIG. 6(A), the beacon signal is constructed by a physical header (15 bytes, in this embodiment), a MAC header (24 bytes, in this embodiment), data (31 bytes, in this embodiment) and an FSC (4 bytes).

In addition, the physical header (PLCP preamble and PLCP header) and the FSC (cyclic redundancy check (CRC 32)) are the same as those of the above-described wireless standard, and therefore, a description of those is omitted here.

The MAC header (IEEE 802.11b header) is further constructed by Frame Control (2 bytes), Duration ID (2 bytes), Address 1 (6 bytes), Address 2 (6 bytes), Address 3 (6 bytes) and Sequence Control (2 bytes).

The Frame Control is a kind of frame or the like, and in this embodiment shown, information indicating that the signal is a beacon signal is described therein. The Duration ID is information of a scheduled time period using a radio wave (time necessary for frame transmission). The Address 1 is information of a MAC address of the destination. In this embodiment shown, the beacon signal is broadcasted but not addressed to a specific portable terminal 14, and therefore, the Address 1 is stored with the information indicative of the broadcasting. The Address 2 is information of MAC address assigned to a transmitter (wireless communication module 22) provided in the sender 12. The Address 3 is also, as similar to the Address 2, information of MAC address assigned to a transmitter (wireless communication module 22) provided in the sender 12. The Sequence Control is information of a sequence number or fragment number.

As shown in FIG. 6(B), in this embodiment shown, the data included in the beacon signal (Frame Body (payload)) includes a Time Stamp (8 bytes), a Beacon Interval (2 bytes), a sender ID (2 bytes), a battery voltage measured value (1 byte), a luminance sensor measuring value (1 byte), number of vibration times (1 byte), a radio wave strength set value (1 byte), a luminance sensor set threshold value (1 byte) and so on.

The Time Stamp is a time stamp, and information of a time (including year, month, day) at a time when the beacon signal is generated. This time information is obtained from the RTC 44. The Beacon Interval is an interval to output (send) the beacon signal. In this embodiment shown, the sending interval is set with a relatively long time such a degree of one (1) second. A reason of this is that power consumption is to be reduced as much as possible because the sender 12 is powered by the battery 48. Furthermore, the sending interval is set such that the beacon signal is surely received by the portable terminal 14 held by the user who moves within a range that the beacon signal (radio wave) reaches (approximately 20-30 meters) by taking such the range and user's moving speed (walking speed) into consideration. In a case that the sender 12 is powered by a commercial power supply, since it is not necessary to consider the dead battery, the sending interval may be shortened to be less than one (1) second (0.1 second, for example) whereby the beacon signal (radio wave) can be received more surely by the portable terminal 14. In addition, the beacon signal actually includes data defined in the wireless standard and data showing various information relating to unique implementations other than the data described above and described later.

The sender ID is identifying information assigned to the sender 12. In this embodiment shown, a number (serial number) is assigned to each sender 12. As described above, since the sender 12 is installed at the predetermined location, after installed at the predetermined location, by making an installed location coincident with the sender ID, and by identifying the sender 12 through the sender ID, it is possible to know the installed location. Therefore, it is possible to also say that the sender ID is identifying information for the installed location of the sender 12 (location ID). Furthermore, in this embodiment shown, the system 10 itself provides some services (user's experiences), and therefore, it is possible to say that the sender ID is information utilized to implement the user experience in the portable terminal 14 which is used in such services. More specifically, the service provides the experience according to a position that the user (portable terminal 14) exists, and therefore, the information available for the service means information that the position that the user exists can be predicted.

The battery voltage measured value is information of a measured voltage value of the battery 48. The luminance sensor measuring value is information of a measured luminance. The number of vibration times is information of the number of times that the vibration (movement or inclination) of the sender 12 is detected. The radio wave strength set value is information as for a setting value of the radio wave strength (a radio wave output, in this embodiment shown). The luminance sensor set threshold value is a luminance threshold value that is set to determine whether the sender 12 is to be operated or stopped. Respective senders 12 are different from each other not only in the installed location but also in the luminance to be detected, and therefore, the luminance sensor set threshold value is decided individually for each the sender 12.

In addition, in a case that the sender 12 is not operated or stopped in accordance with the luminance, it is not necessary to provide such a luminance sensor 28, and in such a case, it is not necessary to include in the beacon signal the information of the luminance sensor measuring value and the luminance sensor set threshold value. For example, by setting a time period (start time and end time) during which the sender 12 is to be operated, the sender 12 may be operated or stopped upon the time counted by the RTC 44 reaching the start time of the time period or the end time of the time period. In such a case, the time period information is to be included in the beacon signal. As the time period, day of the week and date may be designated in addition to the time period.

Furthermore, as described above, in this embodiment shown, in a case that the vibration of the sender 12 is detected by the vibration sensor 30, the alarm is sounded, and therefore, it is possible to also say that the number of vibration times is the number of sounding times of the alarm. In addition, in a case that a sounding duration is made settable, such a setting value (alarm sounding duration set value) may be included in the beacon signal.

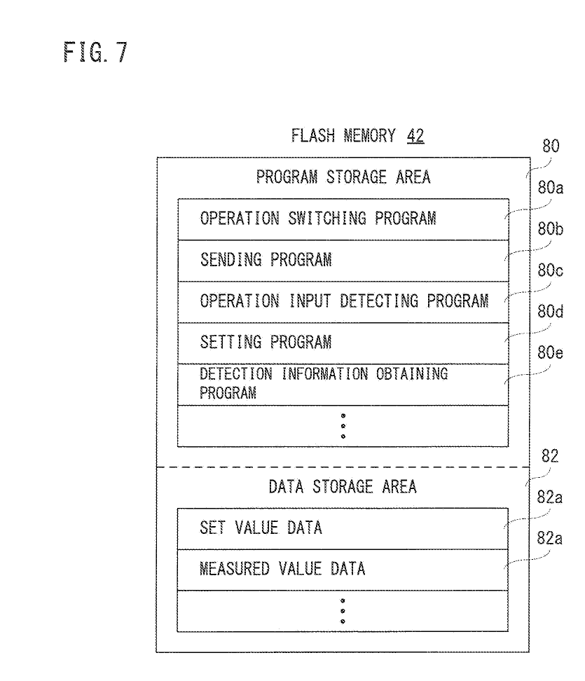

FIG. 7 shows one example of a memory map of the flash memory 42 included in the sender 12 shown in FIG. 4. As shown in FIG. 7, the flash memory 42 includes a program storage area 80 and a data storage area 82. In the program storage area 80, a control program of the sender 12 is stored, which is constructed by an operation switching program 80a, a sending program 80b, an operation input detecting program 80c, a setting program 80d, a detection information obtaining program 80e, and so on.

The operation switching program 80a is a program for switching an operation and a stop of the sender 12 according to the luminance. That is, the operation switching program 80a makes the sending program 80b described later to be started or ended. For example, in a case that the service is to be provided by the system 10 during the daytime, the sender 12 is operated when the luminance is bright at a certain degree and stopped when the luminance becomes dark. Furthermore, in a case that the service by the system 10 is provided within a house or building such as a museum, for example, it is possible to operate the sender 12 during a period that the lighting is put-on in the opening hours and to automatically stop the sender 12 when the lighting is put-off at a closing time. On the other hand, in a case that the service by the system 10 is to be provided in the night-time, the sender 12 may be operated when the luminance is dark at a certain degree, and stopped upon brightened. The luminance sensor set threshold is set to determine the brightness and darkness, and by comparing with luminance detected by the luminance sensor 28, the operation and stop of the sender 12 can be switched. In addition, as described above, the sender 12 may be operated or stopped according to a time period.

The sending program 80b is a program for generating a beacon signal and for sending a generated beacon signal. In addition, the beacon signal is generated and sent at the beacon interval (one (1) second interval, in this embodiment) set by the setting program 80d described later. Furthermore, at a time that the beacon signal is generated by referring the set value data 82a and measured value data 82b both described later, the set value and the measured value of the respective setting items are obtained, and the MAC address from the wireless communication module 22 is obtained.

The operation input detecting program 80c is a program for detecting an operation signal from the switch 26. The setting program 80d is a program for performing an initial setting or changing of the respective setting items of the sender 12 (in this embodiment shown, sender ID, beacon interval, radio wave strength, luminance sensor set threshold value) based on the operation signal detected by the operation input detecting program 80c. Data (set value data 82a) for the respective setting items are stored in the data storage area 82. In addition, the radio wave strength (radio wave output) is stored in the data storage area 82 and set in the wireless communication module 22.

The detection information obtaining program 80e is a program for detecting outputs of the luminance sensor 28, the vibration sensor 30 and the battery voltage detection circuit 50, and for storing in the flash memory 42 the data of the measured luminance, the measured number of vibration times and the measured value of the voltage.

In addition, although not shown, in the program storage area 80, other programs for controlling the sender 12 are also stored.

In the data storage area 82, the set value data 82a, the measured value data 82b and so on are stored.

The set value data 82a is data of a set value of each setting item being set or changed according to the setting program 80d. That is, the set value data 82a is data of the sender ID, the beacon interval, the radio wave strength and the luminance sensor set threshold value. The measured value data 82b is data of measured values detected according to the detection information obtaining program 80e.

Although not shown, the data storage area 82 is further stored with other data necessary for executing the control program of the sender 12 and provided with a counter (timer) and a flag necessary for executing the control program.

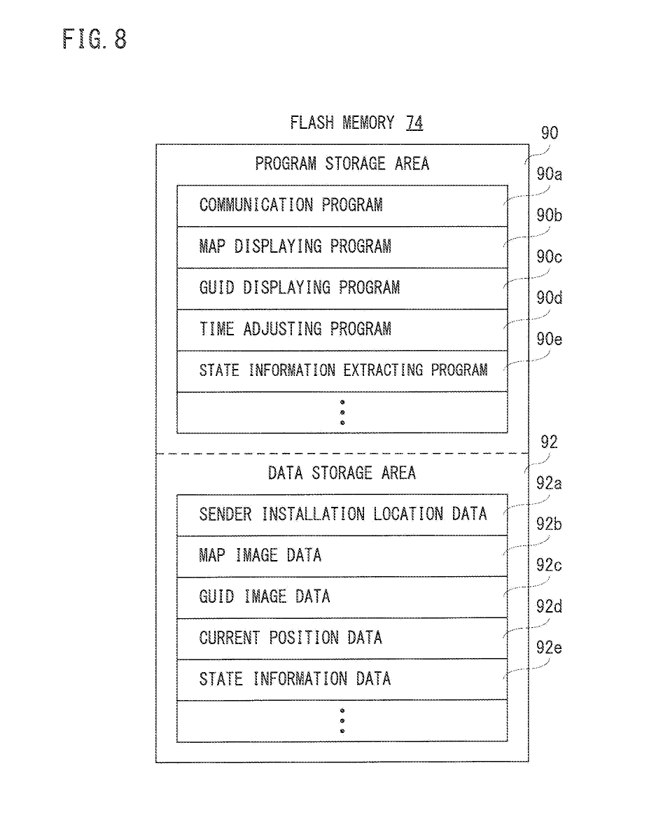

FIG. 8 shows one example of a memory map of the flash memory 74 incorporated within the portable terminal 14 shown in FIG. 5. As shown in FIG. 8, the flash memory 74 includes a program storage area 90 and a data storage area 92.

In the program storage area 90, a control program for controlling the portable terminal 14 is stored, and the control program is constructed by a communication program 90a, a map displaying program 90b, a guide displaying program 90c, a time adjusting program 90d, a state information extracting program 90e and so on.

The communication program 90a is a program for performing communication with other equipment, and in this embodiment shown, by which the beacon signal from the sender 12 is received and state information data 92e described later is transmitted to the central terminal 16. The map displaying program 90b is a program for displaying a map image of the predetermined place 100 on the LCD 70 with using map image data 92h described later, and displaying on the map image a current position of the portable terminal 14 or the user having the portable terminal 14 with using the current position data 92d described later.

The guide displaying program 90c is a program for displaying a guide image on the LCD 70 by using the guide image data 92c described later. Herein, the guide image is displayed, but a voice guide may be output as described above. In such a case, instead of the guide image, data of the voice guide is stored, and although not shown, the voice guide may be output from a speaker or an earphone of the portable terminal 14. Furthermore, both the displaying of the guide image and the output of the voice guide may be performed.

The time adjusting program 90d is a program for adjusting (correcting) a time (including year, month, day) counted by the timer 60a incorporated in the microcomputer 60 of the portable terminal 14 based on the time information (Time Stamp) included in the received beacon signal. Therefore, in a case that the guide information including a time is presented, for example, the portable terminal 14 can provide the guide information with an accurate time being adjusted. The state information extracting program 90e is a program for extracting state information included in the received beacon signal to store the extracted state information data 92e. In this embodiment shown, the state information includes the MAC address, the beacon interval, the sender ID, the battery voltage measured value, the luminance sensor measuring value, the number of vibration times, the radio wave strength set value and the luminance sensor set threshold value.

Although not shown, in the program storage area 90, other programs for controlling the portable terminal 14 are stored.

In the data storage area 92, sender installation location data 92a, map image data 92b, guide image data 92c, current position data 92d, state information data 92e and so on are stored.

The sender installation locations data 92a is data of a correspondent table in which an installed location of the sender 12 that is installed in association with each exhibition object OBJ and the sender ID of the sender 12 are corresponded to each other. For example, as the installation location of the sender 12, coordinates on a map image described later and identifying information of the exhibition object OBJ arranged in the vicinity of the sender are stored. Therefore, it is possible to specify the location on the map image or the object OBJ based on the sender ID.

The map image data 92b is image data corresponding to a birds-eye view (map image) viewing from above the predetermined place 100 shown in FIG. 2. In addition, on the map image, the respective exhibition objects OBJ exhibited in the predetermined place 100 are displayed in a distinguishable manner.

The guide image data 92c is data corresponding to the guide image. As described above, in this embodiment shown, the guide image is information for explaining the content of the exhibition object OBJ (image and text, or only text). Although not shown, the guide image data 92c includes data of the guide image as for each exhibition object OBJ, and the data of each guide image is stored in association with the sender ID of the sender 12 that is installed in the vicinity of the corresponding exhibition object OBJ.

The current position data 92d is position data corresponding to a current position of the portable terminal 14 or the user who uses the portable terminal 14. As described above, since the sender installation location data 92a is stored in a manner that the installation location of each sender 12 and sender ID of each sender are in correspondence to each other, and therefore, as the current position data 92d, the sender ID included in the received beacon signal is stored. As shown in FIG. 2, the sender 12 is installed in the vicinity of the corresponding exhibition object OBJ, and therefore, in a case that the portable terminal 14 (user) exists between two (2) exhibition objects OBJ, for example, there is a possibility that the portable terminal 14 receives the beacon signals from the senders 12 installed in the vicinity of respective exhibition objects OBJ. Therefore, in this embodiment shown, the radio wave strength at a time that the beacon signal is received is detected. Then, in the portable terminal 14, in a case that a plurality of beacon signals are received, it is determined that the sender 12 that is a sending source of the beacon signal having the strongest radio wave strength is installed at a nearest position of the portable terminal 14 (user), and the sender ID included in the beacon signal having the strongest radio wave strength is stored as the current position data 92d.

In addition, in this embodiment shown, since the sender 12 is provided for each exhibition object OBJ, in a case that a plurality of beacon signals are received, only one sender 12 is specified on the basis of the radio wave strength to obtain the position of the portable terminal 14 (user); however, based on the plurality of beacon signals, the position of the portable terminal 14 (user) may be calculated (obtained). By using a technique of PlaceEngine (registered trademark) developed by Sony Computer Science Laboratory, for example, such a position can be calculated.

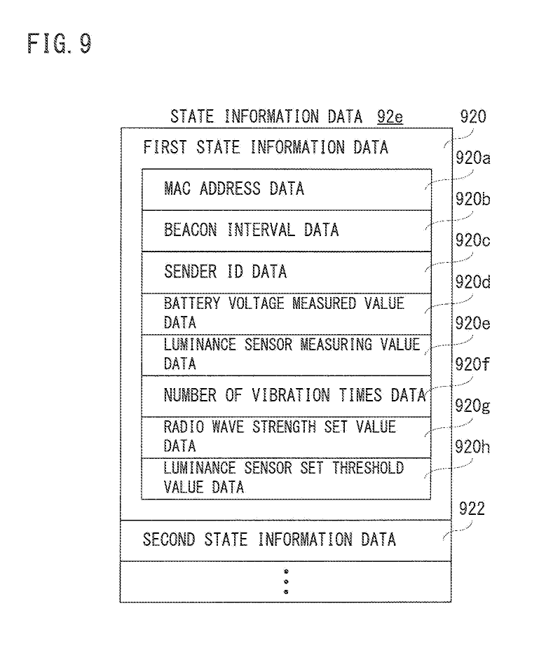

The state information data 92e is data for state information of the sender 12, which is included in the received beacon signal. FIG. 9 shows one example of a specific content of the state information data 92e shown in FIG. 8. The state information data 92e is data including a state relating to setting or operation of the sender 12 that is an origin (sending source) of the beacon signal and an environment state (ambient environment) of the sender 12. As shown in FIG. 9, the state information data 92e includes first state information data 920, second state information data 922, - - - each of which is stored for each sender 12.

The first state information data 920 includes MAC address data 920a, beacon interval data 920b, sender ID data 920c, battery voltage measured value data 920d, luminance sensor measuring value data 920e, the number of vibration times data 920f, radio wave strength set value data 920g and luminance sensor set threshold value data 920h.

These are data (information) included in the beacon signal, and the content of each data has been described above, and therefore, a duplicate description will be omitted here. Furthermore, the second state information data 922 and so on are similar to the first state information data 920.

Although a detailed description is omitted here, in the portable terminal 14, such the state information data 92e is stored (gathered), but if the beacon signal from the same sender 12 is received, the corresponding state information data is over-written (renewed).

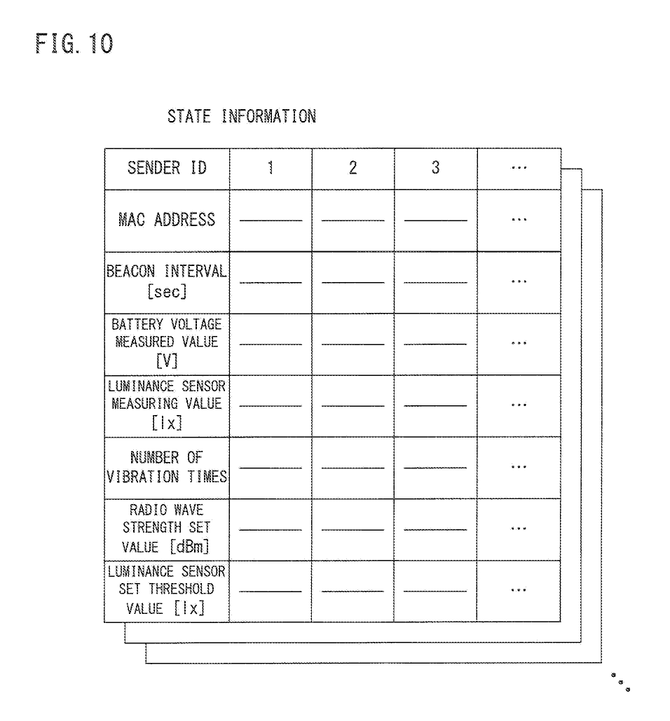

Furthermore, the state information data 92e stored in the portable terminal 14 is totalized in the central terminal 16. As described above, the state information data 920 stored in the portable terminal 14 is transmitted or copied (moved) to the central terminal 16. In the central terminal 16, the state information for all senders 12 are totalized on a day-to-day basis, for example. As shown in FIG. 10, for each sender ID (1, 2, 3, - - - , in this embodiment shown), the state information, that is, MAC address, beacon interval [sec], battery voltage measured value [V], luminance sensor measuring value [lx], the number of vibration times, radio wave strength set value [mW] and luminance sensor set threshold value [lx] are stored. In this embodiment shown, since a plurality of portable terminals 14 are provided, in the central terminal 16, if the state information data of the same sender ID is received from the plurality of portable terminals 14, the state information is over-written by the latest state information data. However, since the battery voltage varies a temperature, a battery voltage that is the smallest one out of battery voltages transmitted from the plurality of portable terminals 14 may be stored.

In addition, in FIG. 10, for simplification, specific values for respective state information are not indicated, but indicated by short crossbars.

Furthermore, although omitted in FIG. 10, for example, in columns for the battery voltage measured values and the luminance sensor measuring values, representative values (maximum value, minimum value, averaged value, standard deviate or the like) out of a plurality of (a number of) measured values are described. At this time, the state information stored-up in the plurality of portable terminals 14 is totalized. Furthermore, in the portable terminal 14, the battery voltage measured value and the luminance sensor measuring value are stored in time series, and therefore, the representative value for each hour may be calculated to be stored. In such a case, it is possible to display a graph of a change with time of the representative value for each hour.

As the state information, since not only the MAC address but also the sender ID are thus controlled or managed, if and when the sender 12 is exchanged, it is possible to omit works for changing the system 10 by assigning the same sender ID to the sender 12 after exchanged. For example, in the central terminal 16, only the MAC address is changed for the exchanged sender 12, it is not necessary to substantially change the data base. Furthermore, because the sender ID is not changed, the data stored in each portable terminal 14 (sender installation location data 92a, map image data 92b, guide image data 92c) can be used as it is. Therefore, operation and control or management of the system is easy.

By utilizing the system 10 of this embodiment shown, it is possible for a system manager or the like to confirm the beacon interval, radio wave strength set value and luminance sensor set threshold value of each of the senders 12 without patrolling the locations of the respective ones of the senders 12, and to determine whether these values are the values having been set in advance. In a case that there is the sender 12 deviated from the set value, the set value can be individually changed. Therefore, it is possible to operate the sender 12 with the set value that the system manager or the like intends to send a stable beacon signal. Furthermore, in a case that the set value is to be changed for each sender 12, it is possible to confirm whether or not the set value is suitable for each sender 12.

Furthermore, the system manager or the like can know a residual quantity of the battery according to the battery voltage measured value by referring to a battery characteristic having been obtained in advance. Therefore, by exchanging or charging the battery 48 in advance, the dead battery can be avoided, and therefore, the stable beacon signal can be sent.

Furthermore, it is possible for the system manager or the like to know whether or not the operation or stop of the sender 12 is correctly switched based on the luminance sensor measuring value and the luminance sensor set threshold value. Furthermore, in a case that the luminance sensor measuring value is clearly different from the others, it is possible to suppose that an abnormal situation occurs in the luminance sensor 28, or that a hindrance or the like is put in the vicinity of the sender 12.

The system manager or the like determines whether or not the installation location of the sender 12 is changed based on the number of vibration times. For example, if the number of vibration times is large, there is a possibility that the installation location of the sender 12 is changed, and in such a case, the service may not be provided correctly. Therefore, if and when the number of vibration times is large, by confirming the installation location of the sender 12, it is possible to return the sender 12 to the correct location.

According to this embodiment shown, the portable terminal, by receiving the beacon signal from the sender, executes a predetermined process based on the sender ID included in the beacon signal, and transmits to the central terminal the state information included in the beacon signal, and therefore, by using the portable terminal, it is possible to collect the state information of the sender while the user receives essential service. Therefore, the system manager or the like of the system and/or sender can perform the maintenance of the sender as necessary by confirming the state information of each of the senders in accordance with a totalized result in the central terminal. That is, it is possible to send the beacon signal stably while the sender is controlled or managed with ease. As a result, it is possible to provide a stable service.

In addition, in this embodiment shown, in the portable terminal which receives the beacon signal, the map image is displayed, the guide image is displayed, and the time is adjusted, but it is not necessary to execute all the processes (services). At least one of the processes may be executed. Furthermore, a service different from these services may be provided. For example, in a theme park, by installing the sender at the storefront in each of the stores, and if the beacon signal from the sender is received, a coupon capable of being used in that store is displayed on the LCD of the portable terminal, and/or a predetermined character is displayed on the LCD of the portable terminal.

In addition, in this embodiment shown, the beacon signal is sent by a radio wave, but if possible for the signal to be received by the portable terminal, the beacon signal may be sent by an ultrasonic wave, an infrared ray, a visible light and so on. In addition, the infrared ray has directivity, and therefore, in installing the sender, it is necessary to consider not only an installation location but also an installation direction.

Furthermore, in this embodiment shown, by operating the cross switch and the push button switch, the respective setting items are set, but dip switches corresponding to the respective setting items may be used to set the setting items.

Furthermore, according to this embodiment shown, the state information is transmitted from the portable terminal to the central terminal through a wireless communication, but not limited thereto. By wire-connecting the portable terminal and the central terminal to each other, the state information may be transmitted. Furthermore, the state information is stored in an external storage medium such as an SD card, and then the SD card is attached to the central terminal to move (copy) the state information.

Furthermore, in this embodiment, although it is described that the system is applied to an exhibition hall as the predetermined place, the system can be applied to an event hall. In such a case, it is possible to present a map image and a current position of a place that each event is performed, and to present a guide of each event content.

Furthermore, in this embodiment, although it is described that the sender is installed indoors such as at the predetermined place, the sender may be installed outdoors. For example, the sender is installed in a location for viewing scenery and animals or plants, and to the user having the portable terminal, a map image and current position can be presented, and guide for the scenery and animals or plants can also be presented.

The state information shown in the embodiments are only examples and thus not limited thereto. Temperature, humidity, sound (environmental sound), atmosphere pressure, wind velocity and so on at the installation location of the sender may be detected as the state information. If necessary, sensors for sensing these items may be provided. In a case that the environmental sound is detected, by setting a predetermined sound volume (threshold value), if the sound (voice) larger than the predetermined threshold value is detected, it is determined that there is someone nearby and the sending of the beacon signal is started and if the sound is smaller than the predetermined threshold value, no beacon signal is sent. That is, according to the environmental sound of the sender, the sender may be operated or stopped.

While certain example system, method, storage media, devices and apparatuses have been described herein, it is to be understood that the appended claims are not to be limited to the systems, methods, storage media, devices and apparatuses disclosed, but on the contrary, are intended to cover various modifications and equivalent arrangements included within the spirit and scope of the appended claims.

What is claimed is:

1. A system comprising at least one portable terminal, at least one sender which sends a signal receivable by the portable terminal, and a central terminal which receives a signal from the portable terminal, wherein
the sender sends a signal including process information relating to a predetermined process to be executed by the portable terminal and state information indicative of a state of at least the sender,
the portable terminal executes the predetermined process with using the process information included in the signal that is received from the sender, and transmits the state information included in the signal to the central terminal, and
the central terminal receives and processes the state information from the portable terminal.

2. A system according to claim 1, wherein the sender is of a portable-type.

3. A system according to claim 1, wherein the sender is powered by a battery, and the state information includes information associated with a residual quantity of the battery.

4. A system according to claim 1, wherein the state information includes information associated with number of times that the sender is moved.

5. A system according to claim 1, wherein the sender includes a luminance sensor, and the state information includes information associated with a detection value of the luminance sensor.

6. A system according to claim 5, wherein the state information further includes information of a threshold value that is to be set for the luminance sensor.

7. A system according to claim 1, wherein the state information includes information associated with a sending interval of the signal.

8. A system according to claim 1, wherein the state information includes information associated with output strength of the signal.

9. A system according to claim 1, wherein the sender includes a transmitter which transmits the state information to the portable terminal, and the state information includes inherent information of the transmitter and identifying information assigned to the sender.

10. A system according to claim 1, wherein the process information includes information relating to a location of the sender.

11. A system according to claim 10, wherein the portable terminal obtains a position of the portable terminal by using the information relating to the location of the sender, and performs the process based on the position of the portable terminal obtained as the predetermined process.

12. A system according to claim 1, wherein the process information includes information of a time counted by the sender.

13. A sender which sends a signal receivable by a portable terminal, wherein the signal includes process information relating to a predetermined process to be executed by the portable terminal and state information indicative of a state of at least the sender itself.

14. A sender according to claim 13, wherein the sender is of a portable-type.

15. A sender according to claim 13, wherein the sender is powered by a battery, and the state information includes information associated with a residual quantity of the battery.

16. A sender according to claim 13, wherein the state information includes information associated with number of times that the sender itself is moved.

17. A sender according to claim 13, wherein the process information includes information relating to a location of the sender itself.

18. A sender according to claim 13, wherein the signal is a beacon signal.

19. A sender according to claim 13, wherein the signal is sent while no address is designated.

20. A control method of controlling equipment by using at least one portable terminal, at least one sender which sends a signal receivable by the portable terminal, and a central terminal which receives a signal from the portable terminal, wherein
the sender sends the signal including process information relating to a predetermined process to be executed by the portable terminal and state information indicative of a state of at least the sender,
the portable terminal executes the predetermined process with using the process information included in the signal received from the sender, and transmits the state information included in the signal to the central terminal, and
the central terminal receives and processes the state information from the portable terminal.
